(19) United States
(12) Patent Application Publication
(10) Pub. No.: US 2003/0014872 A1
(43) Pub. Date: Jan. 23, 2003

(54) Pocket-sized picture hanger

(76) Inventor: Sean Chen, Taipei (TW)

Correspondence Address: RABIN & CHAMPAGNE, P.C., Suite 500, 1101 14th Street, Washington, DC, 20005, US

(21) Appl. No.: 09/908,809

(22) Filed: Jul. 20, 2001

(51) Int. Cl. G01C 15/00

(52) U.S. Cl. 33/286

(57) ABSTRACT

A pocket-sized picture hanger for use in building construction and interior decoration to locate and mark a desired position, mainly includes a base provided with leveling means, and a cover pivotally connected to a top of the base and provided with a light beam projecting means for selectively projecting horizontal or vertical linear beams. The base could be adjusted to a completely horizontal position by adjusting the leveling means, so as to ascertain the levelness or perpendicularity of light beams projected from the light beam projecting means.

### FIELD OF THE INVENTION

The present invention relates to a pocket-sized picture hanger for locating and marking a desired position. The picture hanger projects a horizontal or vertical linear beam, a levelness or perpendicularity of which could be ascertained through adjustment of an inclination of the device.

### BACKGROUND OF THE INVENTION

In the process of building construction and interior decoration, it is often necessary to decide positions for nails by scribing marks on these positions. It is necessary to accurately measure true levelness and true perpendicularity of the marked positions to avoid errors in measurements after completion of the construction or the interior work.

Taiwanese Patent Application No. 82210793 discloses a laser scriber that mainly includes a plate portion, a base-adjusting rack, and a shaft cap. The laser scriber disclosed in the above Taiwanese Patent Application No. 82210793 has complicate structure and does not provide a leveling function, and is not conveniently portable by a user.

It is therefore tried by the inventor to develop a pocket-sized picture hanger that eliminates drawbacks existing in the conventional scribers to upgrade the industrial value of scribing means.

### SUMMARY OF THE INVENTION

A primary object of the present invention is to provide a pocket-sized picture hanger for use in building construction and interior decoration to locate and scribe a position, a levelness and perpendicularity of which could be ascertained with the pocket-sized picture hanger.

Another object of the present invention is to provide a pocket-sized picture hanger that is adapted to project linear beams to determine a levelness and perpendicularity of a located position before scribing the position.

A further object of the present invention is to provide a pocket-sized picture hanger including pivotally connected cover and base, and a fine adjustment element for finely adjusting the cover to an angle relative to the base.

A still further object of the present invention is to provide a pocket-sized picture hanger including pivotally connected cover and base, and a tightening element for locking the cover to a lift position relative to the base.

To achieve the above and other objects, the pocket-sized picture hanger mainly includes a base provided with leveling means, and a cover pivotally connected to a top of the base and provided with a light beam projecting means for selectively projecting horizontal or vertical linear beams. The base could be adjusted to a completely horizontal position by adjusting the leveling means, so as to ascertain the levelness or perpendicularity of the light beams projected from the light beam projecting means. The base is provided with a battery compartment for accommodating batteries to supply power needed by the light beam projecting means to project light beams, and a micro-switch for controlling the supply of power from the batteries to the light beam projecting means. Fine adjustment knob and tightening knob are separately provided at two rear corners of the base to engage with two shaft pins of the cover. By turning the fine adjustment knob and the tightening knob, the cover could be locked to a finely adjusted lifted position relative to the base.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a top front perspective view of a pocket-sized picture hanger according to the present invention, wherein a cover of the device is in a closed position;

FIG. 2 is a top rear perspective view of the pocket-sized picture hanger of FIG. 1, wherein the cover of the device is in a lifted position;

FIG. 3 is an exploded perspective view of the pocket-sized picture hanger of the present invention;

FIG. 4 shows a cover of the pocket-sized picture hanger is lifted to an upright position relative to a base of the device;

FIG. 5 is a fragmentary and enlarged perspective view of FIG. 4 showing a light beam projecting means included in the pocket-sized picture hanger of the present invention;

FIG. 6 is a bottom rear perspective view of the pocket-sized picture hanger of the present invention shown in FIG. 1;

FIG. 7 shows the picture hanger of the present invention is adapted to align with a right-angled edge;

FIG. 8 shows the pocket-sized picture hanger of the present invention projects a vertical linear beam; and

FIG. 9 shows the pocket-sized picture hanger of the present invention projects a horizontal linear beam.

### DETAILED DESCRIPTION OF THE PREFERRED EMBODIMENTS

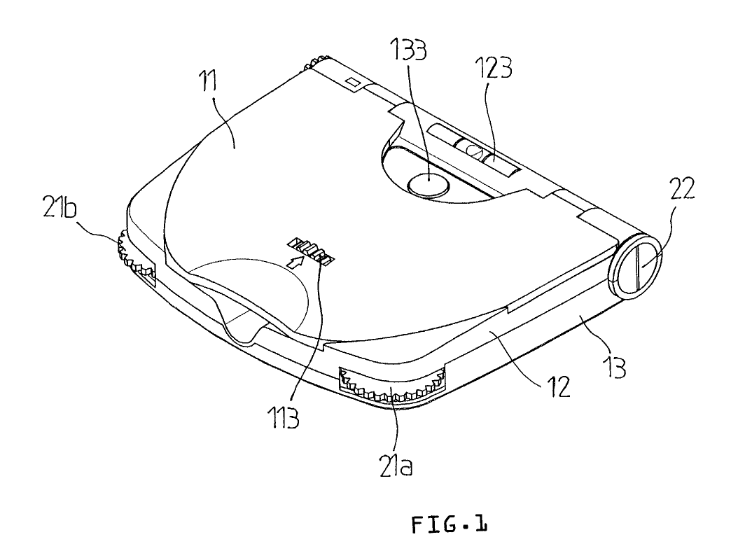

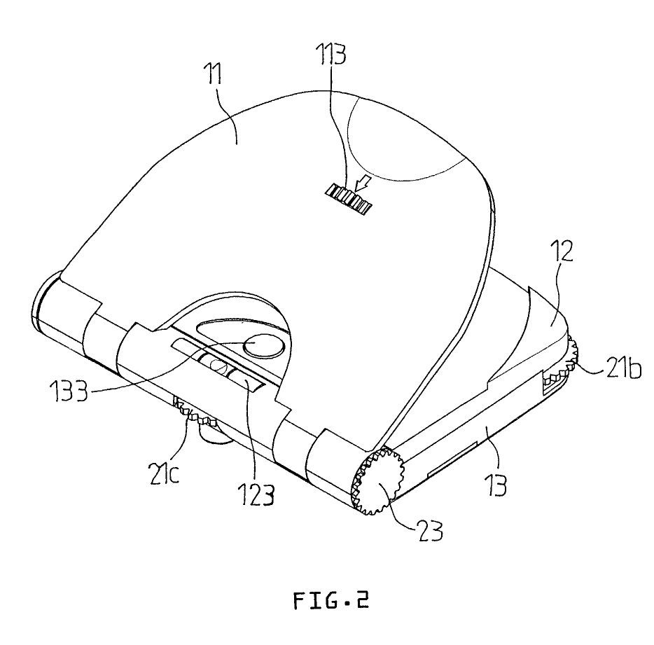

Please refer to FIGS. 1 and 2 that are top front and top rear perspective views, respectively, of a pocket-sized picture hanger according to the present invention for a user to quickly locate and scribe a desired position. For the purpose of simplicity, the pocket-sized picture hanger is referred to as “the picture hanger” hereinafter. As shown in FIGS. 1 and 2, the picture hanger mainly includes a base formed from an upper part 12 and a lower part 13 that are pivotally connected to one another at a rear side thereof, and a cover 11 movably connected to the lower part 13 to locate at a top of the upper part 12 such that the cover 11 could be lifted from or closed to a top of the upper part 12.

There are three turning knobs 21a, 21b, 21c being separately provided on the base of the picture hanger. By rotating these turning knobs 21a, 21b and 21c, the base of the picture hanger could be adjusted to a completely horizontal position. With a bubble-type level 123 provided at a rear center of the upper part 12 of the base, it is possible to ascertain whether the picture hanger on a plane has been adjusted through the turning knobs 21a, 21b and 21c to a completely horizontal position.

The base of the picture hanger also has a micro-switch 133 provided thereto to connect via electric wires to a light beam projecting means 113 provided on the cover 11, so that the light beam projecting means 113 projects either horizontal or vertical linear beams. A levelness or perpendicularity of the horizontal or the vertical linear beams, respectively, could be corrected by adjusting the levelness or perpendicularity of the base of the picture hanger. Moreover, there are a tightening knob 22 and a fine adjustment knob 23 separately provided at two rear corners of the lower part 13 to align with an axis of pivotal connection of the cover 11to the base. By turning the tightening knob 22, the cover 11 could be locked to a desired angle relative to the upper and the lower parts 12, 13. The fine adjustment knob 23 could be turned to allow fine adjustment of an angle at which the cover 11 is lifted from the upper cover 12.

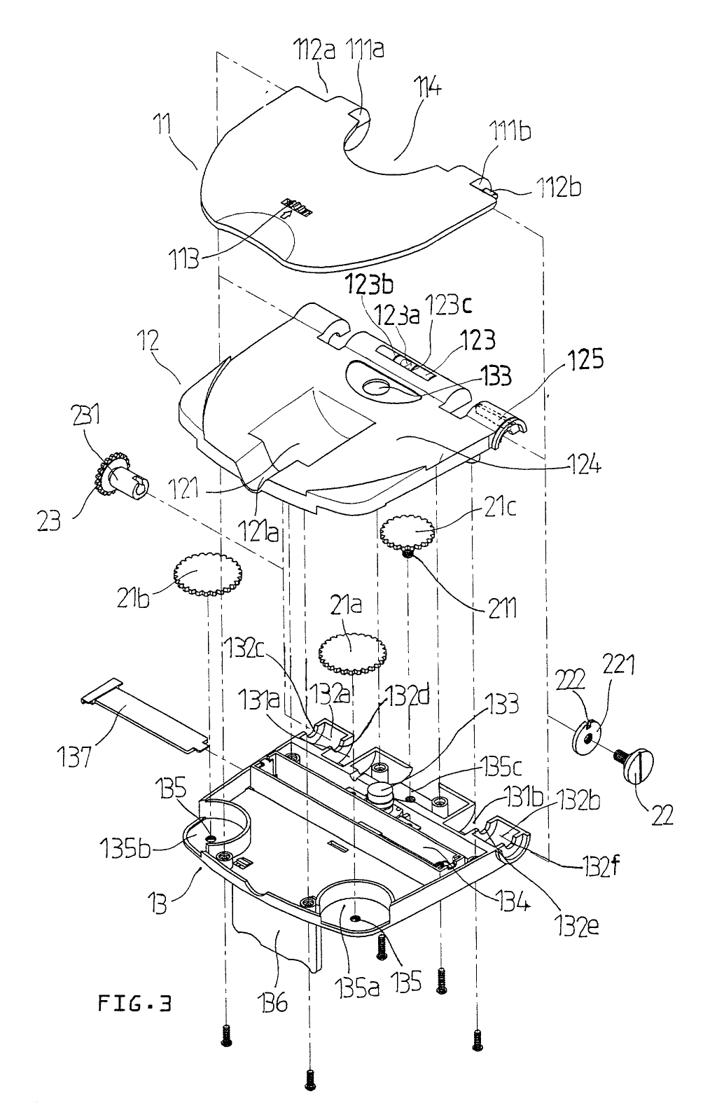

FIG. 3 is an exploded perspective view of the picture hanger of the present invention to show detailed structure thereof. The lower part 13 is internally divided into several areas, one of which is a battery compartment 134 substantially extended across at a middle portion of the lower part 13 for accommodating, for example, a predetermined number of UM-4 batteries or mercury batteries as a power source of the picture hanger. The micro-switch 133 is operated to control a supply of power from the batteries to the light beam projecting means 113. The lower part 13 is formed at two front corners and a rear middle point with circular areas 135a, 135b, 135c, respectively. Each of the three circular areas 135a, 135b, 135c has a central hole 135, through which a screw bolt 211 of each of the turning knobs 21a, 21b, 21c is downward screwed. The turning knobs 21a, 21b and 21c have toothed circumferential edge to facilitate easy application of a rotating force against the turning knobs. Two dents 131a, 131b are formed at two sides of the circular area 135c, and two round-bottomed compartments 132a, 132b are provided at two outer sides of the two dents 131a, 131b. The round-bottomed compartments 132a, 132b are provided at their two ends with two curved notches 132c and 132d, and 132e and 132f, respectively.

The upper part 12 has the same size as that of the lower part 13 for correspondingly covering a top of the lower part 13 with screws. An outer surface (that is, a top surface) of the upper part 12 has a shallow recess 124, a front central portion of which is formed of a deep and narrow recess 121 for receiving the light beam projecting means 113 when the cover 11 is closed to the upper part 12. A most front portion of the narrow recess 121 is a reduced opening 121a. An area of the shallow recess 124 behind a rear end of the narrow recess 121 is a through hole 122 via which the micro-switch 133 is accessed. The level 123 is transversely located behind the through hole 122.

The cover 11 has a size the same as that of the shallow recess 124 on the upper part 12 for fitly and firmly closing onto the shallow recess 124. A rear central portion of the cover 11 is cut away to form a substantially semi-circular opening 114 to expose the level 123 and the micro-switch 133. Two sides of the opening 114 are two rearward extended shaft cylinders 111a, 111b adapted to locate in the two dents 131a, 131b, respectively, of the lower part 13. Two shaft pins 112a, 112b axially extend from an outer side of the shaft cylinders 111a, 111b, respectively, to seat on the curved notches 132d and 132e, respectively.

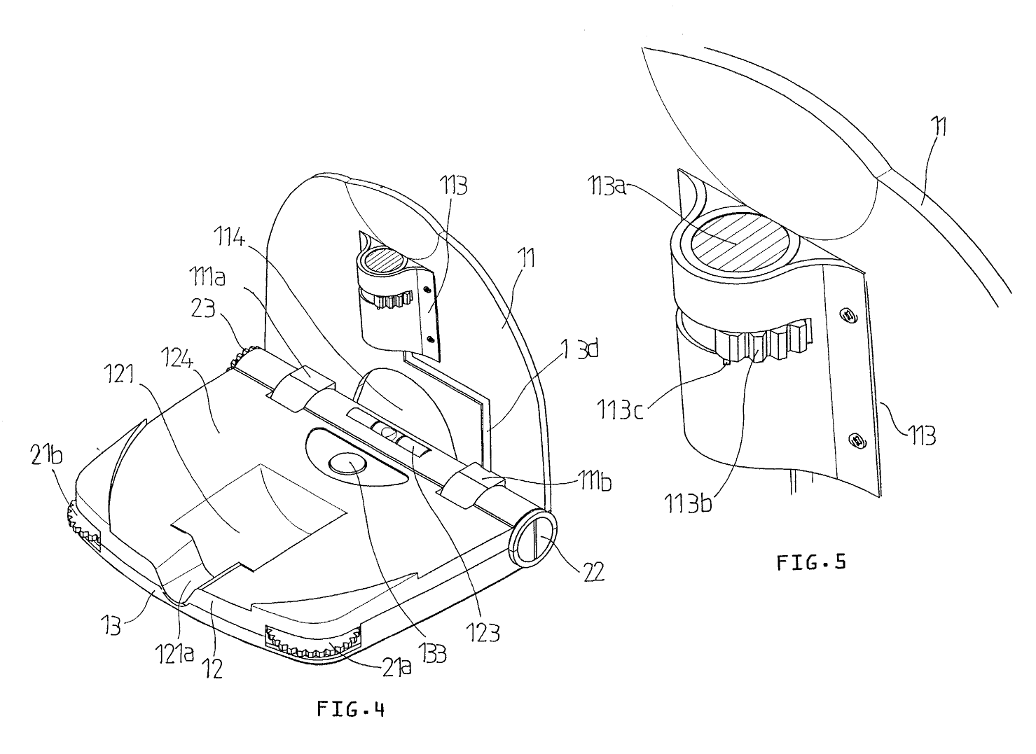

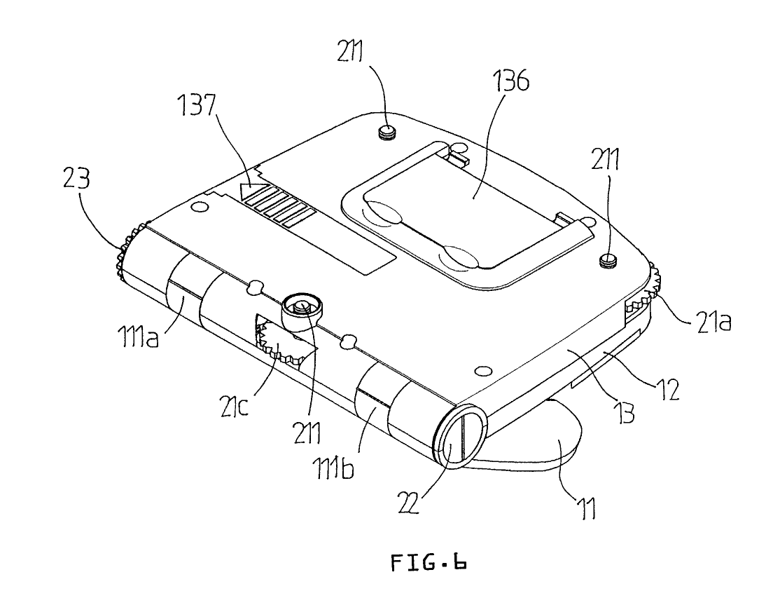

The light beam projecting means 113 is set near a front central portion of the cover 11. Please refer to FIGS. 4 and 5. The light beam projecting means 113 is electrically connected to the battery compartment 134 via electric wires 113d. When the micro-switch 133 is depressed to make the light beam projecting means 113, the latter is able to project light beams contained in the same plane. More specifically, there is a light-emitting element (not shown) provided in the light beam projecting means 113, which is energized via the electric wires 113d to emit a straight projecting beam that passes a corrugated lens 113a mounted at a front end of the light beam projecting means 113 and is converted into many beams contained in the same plane. The beams are projected onto a wall surface to show a straight line. The light beam projecting means 113 also includes a turning knob 113b for adjusting the projected beams into horizontal or vertical position. The turning knob 113b has a length of toothed outer peripheral edge. Two stoppers 113c are separately provided at two outer ends of the toothed edge (in FIG. 5, only one stopper 113c is shown) for limiting the turning knob 113b to a predetermined rotating angle.

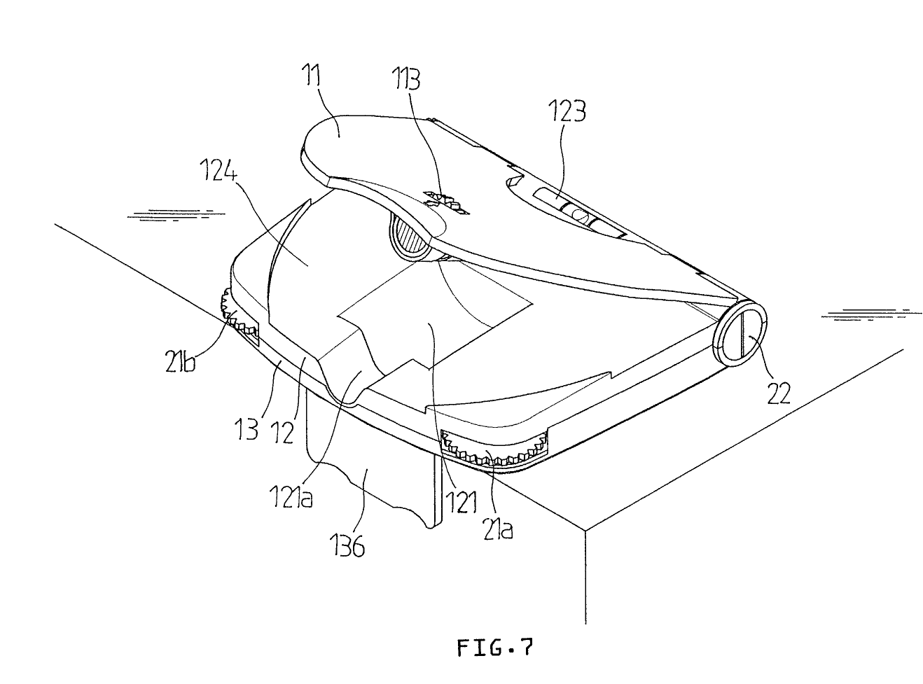

Please refer to FIG. 6 that is a rear bottom perspective view of the picture hanger of the present invention. The screw bolts 211 of the three turning knobs 21a, 21b and 21c extend through the holes 135 to downward project from the lower part 13. By rotating the turning knobs 21, 21b, 21c, it is possible to control lengths of the screw bolts 211 projected from a bottom of the lower part 13 to support the base of the picture hanger in a completely horizontal position. As can be seen from FIG. 6, one half of a bottom of the battery compartment 134 is a hole openably closed by a push plate 137. When the push plate 137 is pushed outward to expose the hole, batteries could be placed into or removed from the battery compartment 134. An alignment plate 136 is pivotally connected to a bottom front of the lower part 13 to move between an extended and a closed position. When the alignment plate 136 is moved to the extended position, it may be pressed against a right-angled edge to facilitate locating of the picture hanger in place, as shown in FIG. 7.

To assemble the picture hanger of the present invention, first hold the cover 11 to an upright position above the lower part 13, and then engage the shaft cylinder 111a, 111b into the dents 131a, 131b, so that the shaft pins 112a, 112b are seated on the curved notches 132d and 132e, respectively. Finally, close the upper part 12 to the top of the lower part 13 to form the base of the picture hanger, so that the cover 11 is pivotally connected to the base. Thereafter, the fine adjustment knob 23 could be rotated to adjust an angle between the cover 11 and the base, particularly the upper part 12. Finally, the tightening knob 22 is rotated to lock the cover 11 to the finely adjusted position relative to the base.

Please refer back to FIG. 3. The tightening knob 22 includes a push disc 221 associated with a screw bolt portion of the knob 22. The push disc 221 is provided at a circumferential edge with a guide notch 222. The tightening knob 22 and the push disc 221 are together positioned in the round-bottomed compartment 132b with the screw bolt portion of the knob 22 seated on the curved notch 132f and the guide notch 222 on the push disc 221 engaged with a rib 125 downward projected from an inner (or a bottom) surface of the upper part 12. When the tightening knob 22 is rotated, the push disc 221 is caused to move inward or outward along the screw bolt portion relative to the round-bottomed compartment 132b. When the tightening knob 22 is rotated, for example, clockwise, for the push disc 221 to move to an innermost position, the push disc 221 would tightly press against the shaft pin 112b to lock the cover 11 in a fixed position.

The fine adjustment knob 23 includes a sleeve portion 231 and is connected in advance to the cover 11 with the shaft pin 112a tightly fitted in the sleeve portion 231. After the cover 11 with the fine adjustment knob 23 mounted thereto is vertically connected to the lower part 13 as mentioned above, the position of the cover 11 relative to the base could be finely adjusted by turning the fine adjustment knob 23.

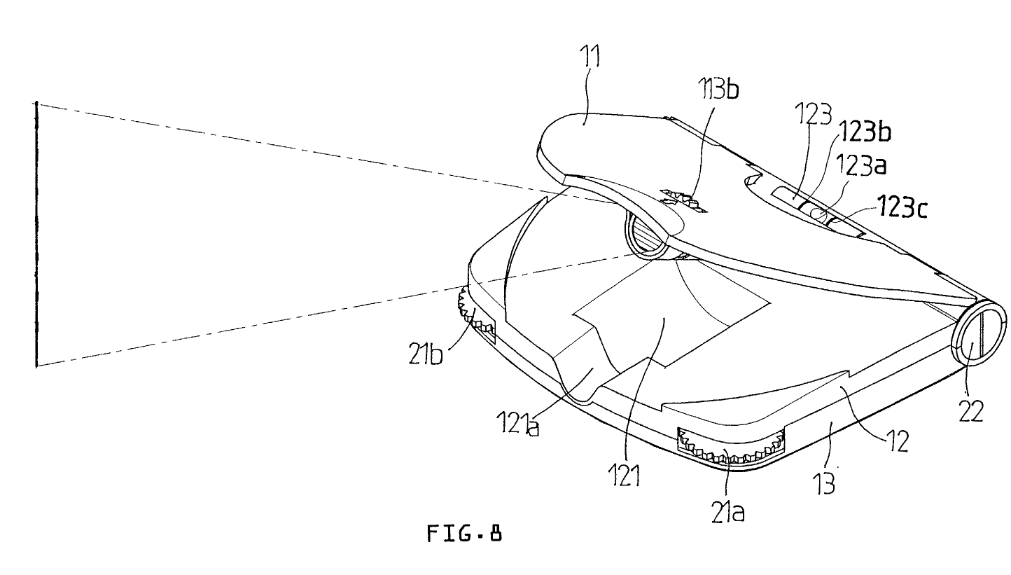

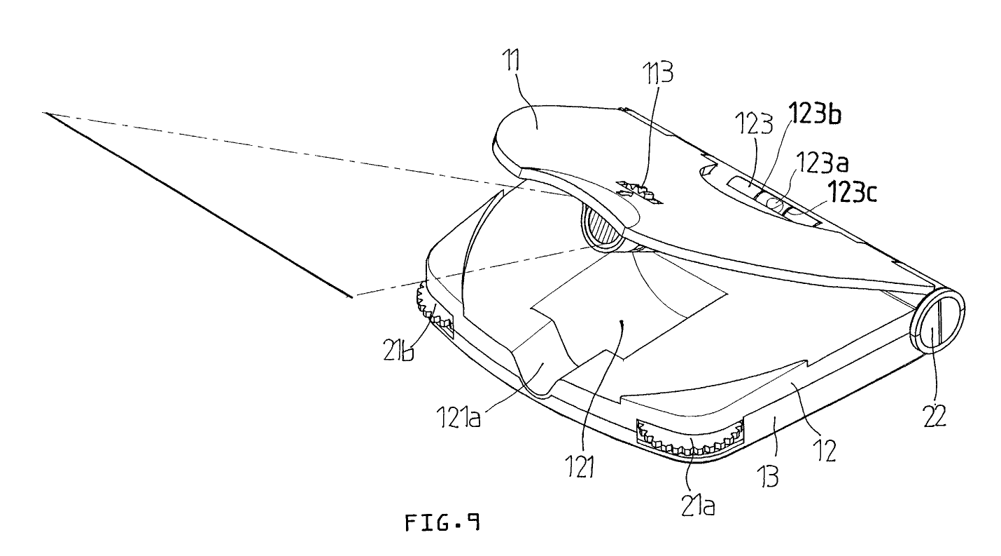

Please refer to FIGS. 8 and 9. When the micro-switch 133 is depressed, the light beam projecting means 113 is turned on to project light beams in the same plane. By rotating the turning knob 113b, a user may select horizontal or vertical linear light beams. To determine the levelness or perpendicularity of the horizontal or the vertical light beams, respectively, simply turn the turning knobs 21a, 21b and 21c to adjust the inclination of the base, and observe a bubble 123a in the level 123. When the bubble 123a is located between two marks 123b and 123c and keeps still, it means the base of the picture hanger is in a horizontal position, and the levelness or perpendicularity of the projected light beams from the light beam projecting means 113 could be ascertained.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A pocket-sized picture hanger, comprising:
a base, on which leveling means and power supply means are provided; said leveling means including a level and a plurality of turning knobs separately located at predetermined positions on said base for determination of levelness of said base on a plane, and said power supply means being provided in said base at predetermined positions; and
a cover being detachably and pivotally connected to said base to be lifted from or closed onto a top of said base, and having a light beam projecting means provided thereon at a predetermined position for selectively projecting horizontal or vertical linear beams; and said light beam projecting means being electrically connected to said power supply means via electric wires.

2. The pocket-sized picture hanger as claimed in claim 1, wherein said base includes a lower part and an upper part openably closed to a top of said lower part.

3. The pocket-sized picture hanger as claimed in claim 2, wherein said level is transversely provided at a top rear side of said upper part of said base.

4. The pocket-sized picture hanger as claimed in claim 3, wherein said level is a bubble-type level.

5. The pocket-sized picture hanger as claimed in claim 2, wherein said turning knobs are connected to said lower part of said base, such that a part of each said turn knob is accessible from outside of said base after said upper part has been closed to said lower part.

6. The pocket-sized picture hanger as claimed in claim 5, wherein each said turning knob has a toothed circumferential edge and a screw bolt portion connected to a bottom side thereof, said screw bolt portions being downward threaded to project from a bottom of said lower part, and a length of each said screw bolt portion downward projected from said lower part of said base being adjustable by rotating each said turning knob at said toothed circumferential edge.

7. The pocket-sized picture hanger as claimed in claim 2, wherein said power supply means are provided on said lower part of said base.

8. The pocket-sized picture hanger as claimed in claim 7, wherein said power supply means include batteries received in a battery compartment formed at an inner side of said lower part, and a micro-switch for controlling a supply of power from said batteries to said light beam projecting means on said cover.

9. The pocket-sized picture hanger as claimed in claim 2, wherein said upper part of said base is provided at an upper side at a predetermined position with a recess to accommodate said light beam projecting means when said cover is closed to the top of said base.

10. The pocket-sized picture hanger as claimed in claim 1, further comprises a fine adjustment knob provided at a rear corner of said base to engage with a shaft pin of said cover for pivotally connecting said cover to said base, and said fine adjustment knob being rotatable to finely adjust an angle at which said cover is lifted from said base.

11. The pocket-sized picture hanger as claimed in claim 10, further comprises a tightening knob provided at another rear corner of said base to engage with another shaft pin of said cover, and said tightening knob being rotatable to lock said cover to a lifted position relative to said base.
